(19) United States
(12) Patent Application Publication
(10) Pub. No.: US 2014/0042181 A1
(43) Pub. Date: Feb. 13, 2014

(54) HERMETICALLY SEALED GOODS ACCESS DOOR ASSEMBLY FOR VENDING MACHINE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); CHUNG CHAI, New Taipei (TW); DA-LONG SUN, Wuhan (CN); LI TONG, Wuhan (CN); JUN-ZHI XU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/898,631

(22) Filed: May 21, 2013

(30) Foreign Application Priority Data
Aug. 13, 2012 (CN) 2012102858535

(51) Int. Cl. A47F 3/02; G07F 9/10

(52) U.S. Cl. CPC A47F 3/02; G07F 9/10
USPC 221/306

(57) ABSTRACT

A goods access door assembly for a vending machine includes an outer plate, a hermetic seal, and a goods bracket. The outer plate defines an access opening. A hermetic seal is mounted on the inner side of the outer plate and surrounding the access opening and functions to isolate the goods in the vending machine from a hotter or colder ambient temperature until the moment that the goods are taken out of the vending machine.

### BACKGROUND

1. Technical Field

The present disclosure relates to vending machines, and more particularly to a goods picking door assembly for a vending machine.

2. Description of Related Art

A vending machine provides twenty-four hours services. Different kinds of goods, such as cold and hot beverages, are provided by the vending machine. When the cool or hot beverage is sent to an access door of the vending machine, a temperature of the beverage may be influenced by external environment, such that the cool beverage may become heated, and vice versa. Such experiences may lead to unsatisfied customers.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a goods access door assembly of a vending machine.

FIG. 2 is an enlarged view of encircled portion II of FIG. 1.

FIG. 3 is similar to FIG. 2, but viewed from another aspect.

FIG. 4 is an assembled view of the goods picking door assembly of FIG. 1.

FIG. 5 is a sectional view in an enlarged scale taken along line V-V of FIG. 4.

FIG. 6 is an enlarged view of encircled portion VI of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

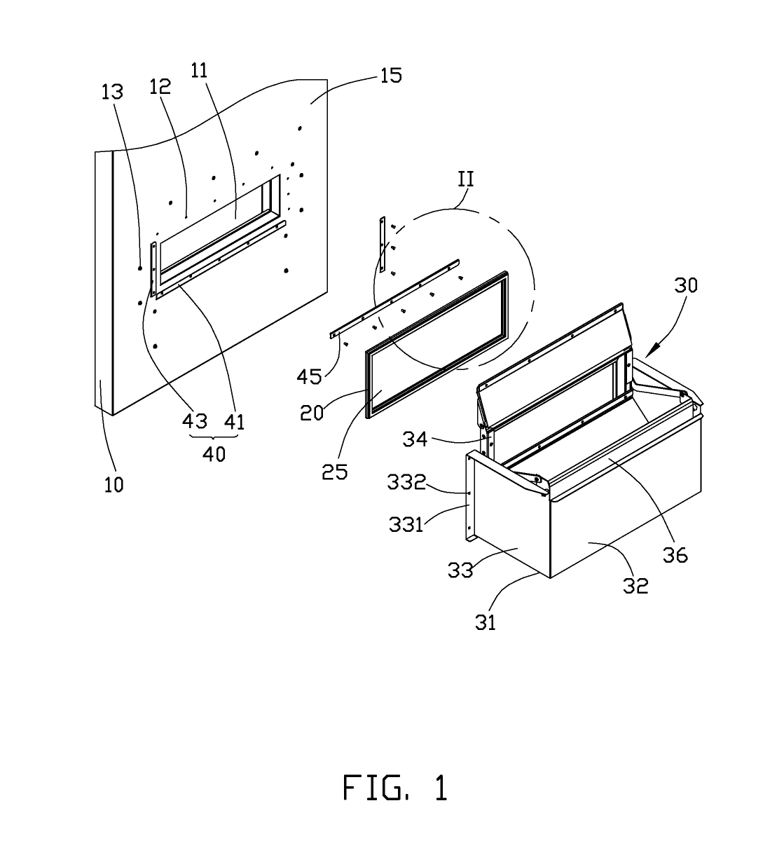

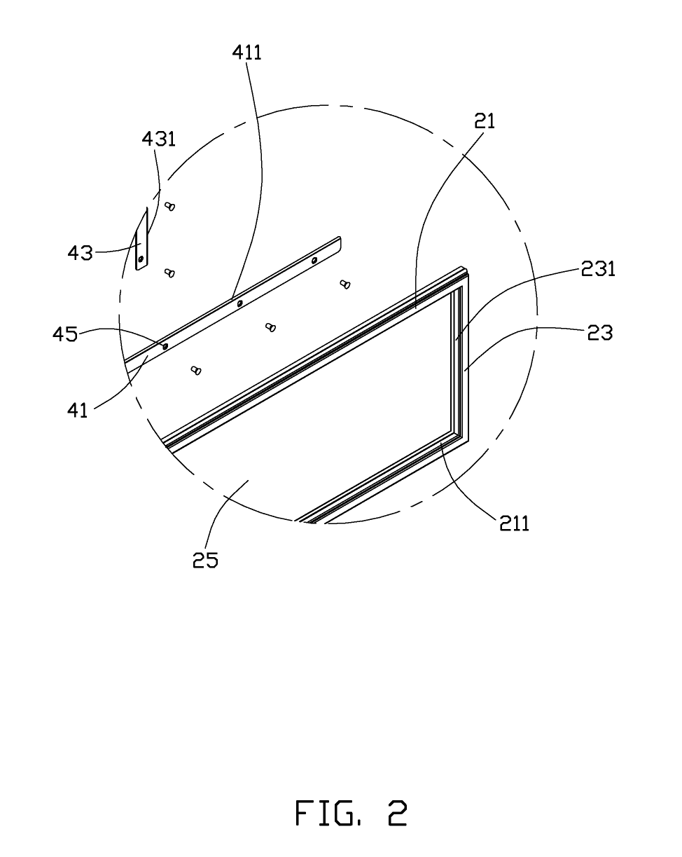

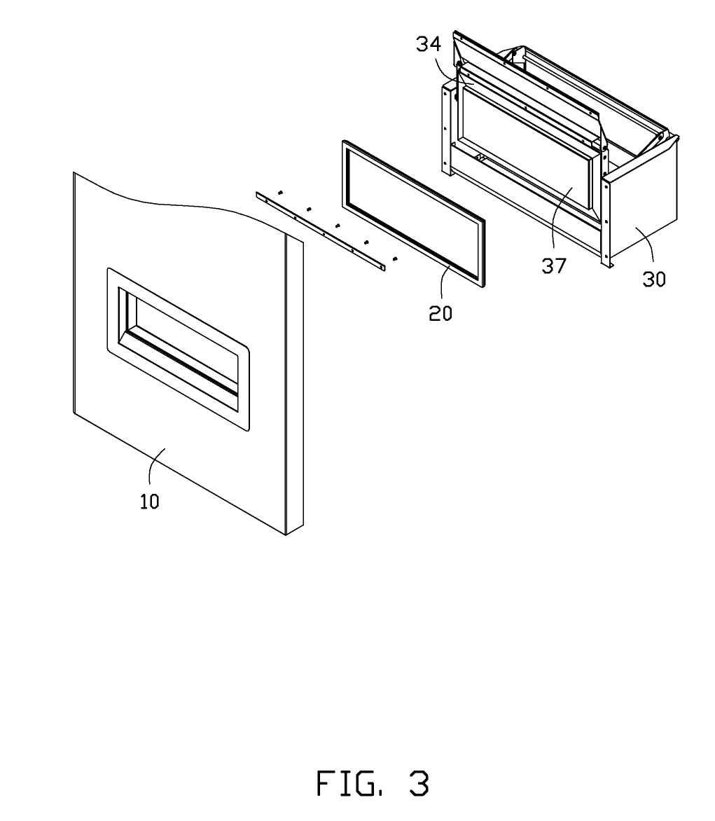

FIGS. 1 to 3 show one embodiment of a goods picking door assembly for a vending machine. The goods picking door assembly includes an outer plate 10, a strip assembly 40, a hermetic seal 20, and a goods bracket 30.

The outer plate 10 defines an access opening 11. An inner side 15 of the outer plate 10 defines a plurality of first fixing holes 12 and second fixing holes 13 surrounding the access opening 11.

The hermetic seal 20 includes a pair of parallel long edges 21 and a pair of parallel short edges 23. The hermetic seal 20 is made of resilient and elastic material, such as rubber. The pair of short edges 23 are perpendicular to the pair of long edges 21. The pair of parallel long edges 21 and the pair of parallel short edges 23 surrounds a through opening 25. A side of each long edge 21 facing to the through opening 25 defines a first groove 211. A side of each short edge 23 facing to the through opening 25 defines a second groove 231. A size of the through opening 25 is slightly larger than a size of the access opening 11.

The strip assembly 40 includes two long hermetic strips 41 and two short hermetic strips 43. Each of the two long hermetic strips 41 and the two short hermetic strips 43 defines a plurality of first through holes 45 corresponding to the plurality of first fixing holes 12 of the outer plate 10. An outer side of each long hermetic strip 41 forms a first inserting flange 411. An outer side of each short hermetic strip 43 forms a second inserting flange 431.

The goods bracket 30 includes a bottom wall 31, a rear wall 32, two side walls 33, and a front wall 34. The rear wall 32 is perpendicularly connected to a rear edge of the bottom wall 31. Two side walls 33 are perpendicularly connected to left and right edges of the bottom wall 31. The front wall 34 is perpendicularly connected to a front edge of the bottom wall 31. The front wall 34 is parallel to the rear wall 32. The two side walls 33 are parallel to each other. A receiving room 36 is surrounded by the bottom wall 31, the rear wall 32, the front wall 34, and two side walls 33. The receiving room 36 is adapted to receive goods selected from the vending machine. A door 37 is movably mounted on the front wall 34. The door 37 protrudes from the front wall 34. A pair of fixing pieces 331 is connected the front wall 34. Each of the pair of fixing pieces 331 defines a plurality of second through holes 332 corresponding to the second fixing holes 13 of the outer plate 10.

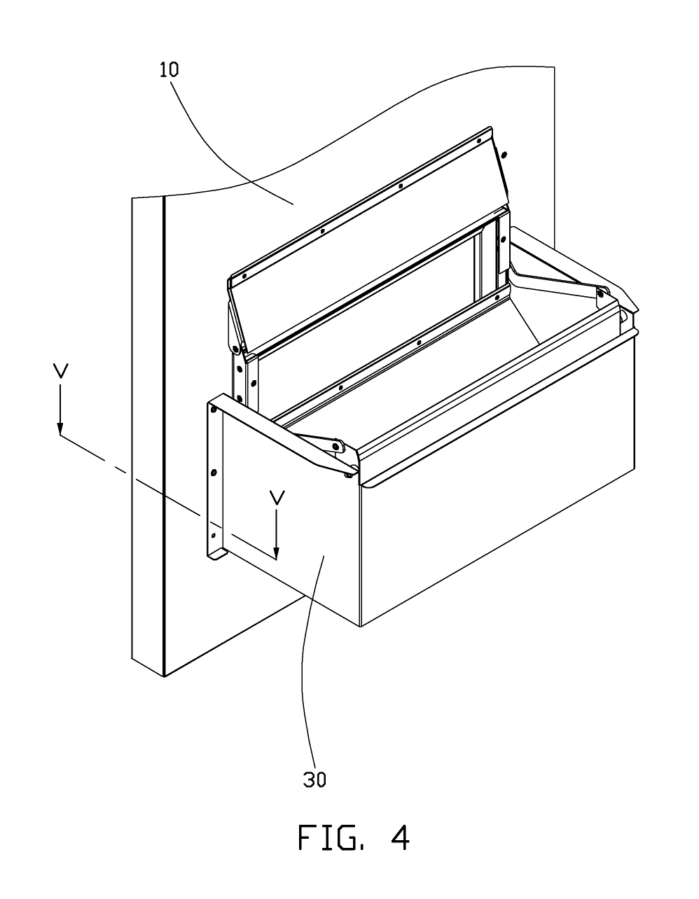

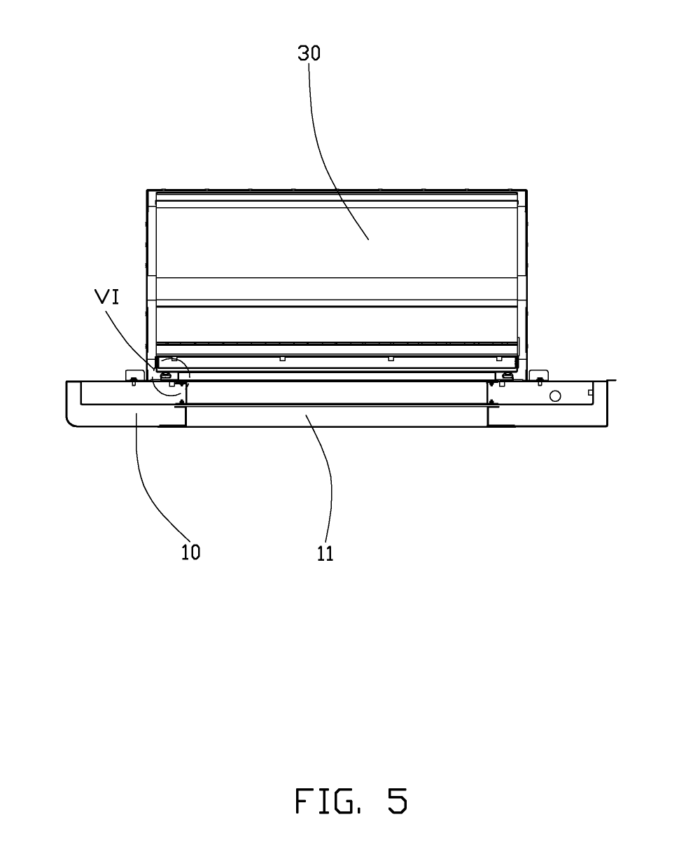

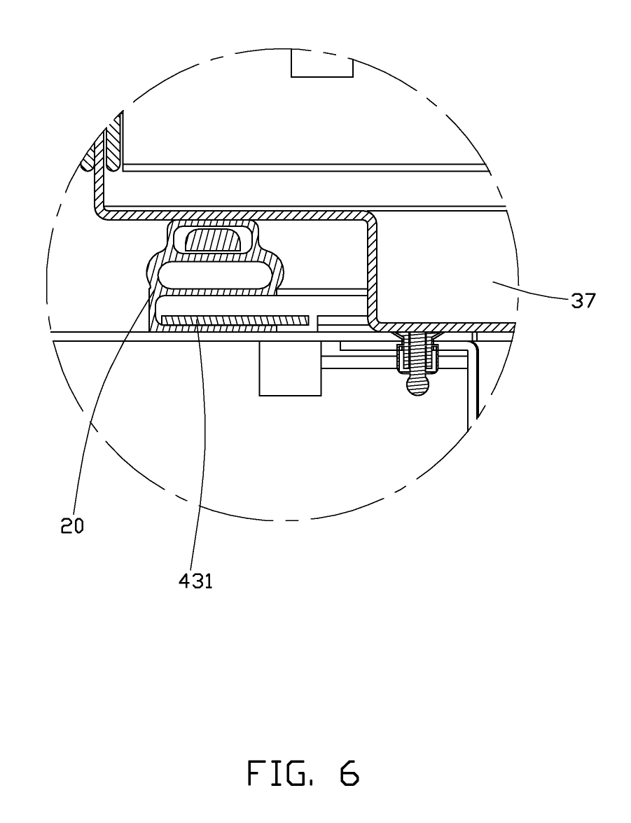

Referring to FIGS. 4 to 6, in assembly, the through holes 45 of the two long hermetic strips 41 and the two short hermetic strips 43 are aligned to the first fixing holes 12. A plurality of screws are mounted in the through holes 45 and the first fixing holes 12 to mount the strip assembly 40 on the inner side 15 of the outer plate 10. At this position, the two long hermetic strips 41 are parallel to each other, and the two short hermetic strips 43 are parallel to each other. The two short hermetic strips 43 are perpendicular to the two long hermetic strips 41. Then, the hermetic seal 20 is slightly stretched to be set on the strip assembly 40. The first inserting flanges 411 of the long hermetic strips 41 are inserted in the first grooves 211 of the long edges 21 of the hermetic seal 20. The second inserting flanges 431 of the short hermetic strips 43 are inserted in the second grooves 231 of the long edges 23. Thereby, the hermetic seal 20 is secured on the inner side 15 of the outer plate 10. The access opening 11 is located in the through opening 25.

The second through holes 332 of the goods bracket 30 are aligned to the second fixing holes 13 of the outer plate 10. A plurality of screws are mounted in the second through holes 332 and the second fixing holes 13 to fix the goods bracket 30 on the outer plate 10. At this position, the door 37 of the goods bracket 37 is located in the through opening 25 and aligned to the access opening 11. Periphery of the doors 37 abuts an inner side of the hermetic seal 20 to seal the door 37.

In the above goods picking door assembly, because the door 37 is sealed by the hermetic seal 20, a temperature of goods received in the goods bracket 30 is substantially maintained.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A goods access door assembly, comprising:
an outer plate defining an access opening, the outer plate comprising an inner side;
a hermetic seal mounted on the inner side of the outer plate and surrounding the access opening; and
a goods bracket mounted on the inner side of the outer plate, the goods bracket comprising a front wall, a door mounted on the front wall, the door being protruded on the front wall and aligned to the access opening, and a periphery of the door being sealed by the hermetic seal.

2. The goods access door assembly of claim 1, wherein the hermetic seal comprises a pair of parallel long edges and a pair of parallel short edges, the pair of parallel short edges are perpendicular to the pair of parallel long edges, and the pair of parallel long edges and the pair of parallel short edges together surround the access opening.

3. The goods access door assembly of claim 2, wherein a pair of long hermetic strips and a pair of short hermetic strips are mounted on the inner side of the outer plate to form a strip assembly, the hermetic seal is made of elastic material, the hermetic seal is stretch fitted to the strip assembly with the pair of long edges abutting on the pair of long hermetic strips and the pair of short edges abutting on the pair of short hermetic strips.

4. The goods access door assembly of claim 3, wherein an inner portion of each of the pair of parallel long edges and the pair of parallel short edges defines a groove, and each of the pair of long hermetic strips and the pair of short hermetic strips forms an inserting flange, and the inserting flange is inserted in the groove.

5. The goods access door assembly of claim 3, wherein the inner side of the outer plate defines a plurality of first fixing holes, the strip assembly defines a plurality of first through holes, and a plurality of screws are mounted in the plurality of first fixing holes and the plurality of first through holes.

6. The goods access door assembly of claim 1, wherein the goods bracket defines a receiving room, the door is movably mounted on the front wall, and the door is configured to move away from the access opening to enter the receiving room through the access opening.

7. The goods access door assembly of claim 1, wherein the goods bracket comprises a bottom wall, a rear wall, two side walls, and a front wall, the rear wall is perpendicularly connected to a rear edge of the bottom wall, each of the two side walls is perpendicularly connected to each of a left edge and a right edge of the bottom wall, the front wall is perpendicularly connected to a front edge of the bottom wall, and the bottom wall, the rear wall, and two side walls cooperatively define the receiving room thereamong.

8. The goods access door assembly of claim 7, wherein the rear wall is parallel to the front wall, the two side walls are parallel to each other.

9. A goods access door assembly, comprising:
an outer plate comprising an inner side, an access opening defined in the outer plate and extending through the inner side;
a strip assembly mounted on the inner side of the outer plate to surround the access opening;
an elastic hermetic seal set on the strip assembly; and
a goods bracket mounted on the inner side of the outer plate, the goods bracket comprising a door aligned to the access opening, the door is adapted to be opened to access the goods bracket, and a periphery of the door is sealed by the hermetic seal.

10. The goods access door assembly of claim 9, wherein the hermetic seal comprises a pair of parallel long edges and a pair of parallel short edges, the pair of parallel short edges are perpendicular to the pair of parallel long edges, and the pair of parallel long edges and the pair of parallel short edges together surrounds the access opening.

11. The goods access door assembly of claim 10, wherein the strip assembly comprises a pair of long hermetic strips and a pair of short hermetic strips mounted on the inner side of the outer plate the hermetic seal is elastically stretched to fit on the strip assembly with the pair of long edges abutting on the pair of long hermetic strips and the pair of short edges abutting on the pair of short hermetic strips.

12. The goods access door assembly of claim 11, wherein an inner portion of each of the pair of parallel long edges and the pair of parallel short edges defines a groove, and each of the pair of long hermetic strips and the pair of short hermetic strips forms an inserting flange, and the inserting flange is inserted in the groove.

13. The goods access door assembly of claim 9, wherein the inner side of the outer plate defines a plurality of first fixing holes, the strip assembly defines a plurality of first through holes, and a plurality of screws are mounted in the plurality of first fixing holes and the plurality of first through holes.

14. The goods access door assembly of claim 9, wherein the goods bracket comprises a bottom wall, a rear wall, two side walls, and a front wall, the rear wall is perpendicularly connected to a rear edge of the bottom wall, each of the two side walls is perpendicularly connected to each of a left edge and a right edge of the bottom wall, the front wall is perpendicularly connected to a front edge of the bottom wall, and the bottom wall, the rear wall, and two side walls cooperative define a receiving room thereamong.

15. The goods access door assembly of claim 14, wherein the rear wall is parallel to the front wall, the two side walls are parallel to each other.
